(19) United States
(12) Patent Application Publication
(10) Pub. No.: US 2017/0267460 A1
(43) Pub. Date: Sep. 21, 2017

(54) BEVERAGE BOTTLE TRANSPORT DEVICE IN A BEVERAGE BOTTLING PLANT

(71) Applicants: Carsten BUCHWALD, Bad Breisig (DE); Jürgen-Peter HERRMANN, Rosenheim (DE); Marius Michael HERRMANN, Rosenheim (DE); Wolfgang SCHORN, Hönningen (DE); Xiang ZHANG, Wetter (DE)

(72) Inventors: Carsten BUCHWALD, Bad Breisig (DE); Jürgen-Peter HERRMANN, Rosenheim (DE); Marius Michael HERRMANN, Rosenheim (DE); Wolfgang SCHORN, Hönningen (DE); Xiang ZHANG, Wetter (DE)

(21) Appl. No.: 15/452,156

(22) Filed: Mar. 7, 2017

Related U.S. Application Data
(63) Continuation-in-part of application No. PCT/EP2015/066030, filed on Jul. 14, 2015.

(30) Foreign Application Priority Data
Sep. 8, 2014 (DE) 10 2014 112 886.9

(51) Int. Cl. B65G 43/00; G06K 9/20

(52) U.S. Cl. CPC B65G 43/00; G06K 9/2036; B65G 2203/041; B65G 2203/0275

(57) ABSTRACT

A beverage bottle transport device in a beverage bottling plant. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/EP2015/066030, filed on Jul. 14, 2015, which claims priority from Federal Republic of Germany Patent Application No. 10 2014 112 886, filed on Sep. 8, 2014. International Patent Application No. PCT/EP2015/066030 was pending as of the filing date of this application. The United States was an elected state in International Patent Application No. PCT/EP2015/066030.

### BACKGROUND

### 1. Technical Field

The present application relates to a beverage bottle transport device in a beverage bottling plant.

### 2. Background Information

The present application relates to a beverage bottle transport device in a beverage bottling plant. Most beverage bottling plants include multiple devices and/or machines for handling the bottles. Such machines include beverage bottle cleaning or rinsing machines to clean both the insides and outsides of beverage bottles. A beverage bottle filling machine is used to fill the beverage bottles with a liquid beverage. The beverage bottle filling machine is often of a revolving or rotary design and includes a rotor that revolves around a central, vertical machine axis. The rotor can be designed to receive and hold the beverage bottles for filling at a plurality of filling positions located about the periphery of the rotor.

After the beverage bottles are filled, the beverage bottles are moved to a beverage bottle closing machine, which closes or caps the beverage bottles. A beverage bottle labeling machine is also usually included in the beverage bottling plant. The beverage bottle labeling machine is designed to apply labels to the beverage bottles, and/or print on the beverage bottles or the labels. Finally, a beverage bottle packaging machine arranges the beverages bottles in packs, packages, or boxes for shipping out of the beverage bottling plant.

All of these beverage bottle handling machines in the beverage bottling plant are connected by beverage bottle transport devices designed to move the beverage bottles from one machine to the next. There are many different kinds of beverage bottle transport devices, such as star wheels, conveyor belts, transport chains, guide plates, and gripper arms. Since many modern beverage bottling plants can handle upwards of 70,000 to 100,000 beverage bottles per hour, these beverage bottle transport devices experience considerable use, and thus considerable wear and tear.

In addition, beverage bottling plants are usually run as continuously as possible in order to maximize production. It is therefore important that the beverage bottling plant machines and components run as optimally as possible. However, machines and components experience wear and tear over their lifetimes, so maintenance and/or repair is necessary to keep the beverage bottling plant machines and components running optimally. Unfortunately, maintenance and/or repair often requires that the beverage bottling plant, or at least a portion thereof, be shut down in order to perform the maintenance and/or repair. As mentioned above, it is most advantageous to keep the beverage bottling plants running as continuously as possible, so minimizing such downtime for maintenance and/or repair is important.

For example, conveyor belt surfaces, when in operation, are subject to different stresses or wear and tear, such as, for example, wear, dirt, or even damage, which makes regular maintenance and upkeep intervals necessary and/or desired. Currently, the appropriate measures are carried out at a set interval of time, regardless of the condition of the actual surface of the belt. In other words, maintenance and/or repair checks are performed based on a time schedule, even if the conveyor belt is in an acceptable working condition. Again, such periodic maintenance and/or repair activities for the beverage bottle transport devices, such as conveyor belts, results in downtime while the maintenance and/or repair activities are performed. Such downtime could possibly be unnecessary if the beverage bottle transport device is in an acceptable working condition, and thus could cause an unnecessary loss of production for the beverage bottling plant. It should be noted that the terms “stress” and “stresses,” as used herein, refer to all types of wear and tear, such as physical damage, wear, mechanical failure, tearing, etc., and refer to all types of materials on the beverage bottle transport device, such as dirt, broken bottle materials, spilled liquid beverage, lubricants, etc.

It therefore would be advantageous to perform maintenance and/or repair activities only when needed to fix or correct a problem with a beverage bottle transport device that is sufficient to affect performance of the beverage bottling plant. In order to adjust the maintenance and upkeep interval to the actual requirement, it would be advantageous for the state of a component of a beverage bottle transport device, such as a beverage bottle transport surface of a conveyor belt, and any changes to the component of the beverage bottle transport device, to be monitored constantly or substantially constantly, in order to be able to deal rapidly with stress damage or other substantial wear and tear which may occur.

### OBJECT OR OBJECTS

An object of the present application is to provide a method and apparatus for monitoring a beverage bottle transport device and components thereof, such as a surface of a conveyor belt.

### SUMMARY

The present application solves this object by a method and a device with the features disclosed in the present application. Further exemplifications of the present application are described in the present application. The features described are in principle the object of the present application, individually or in any desired combination.

The present application proposes to utilize a detection and monitoring system to monitor beverage bottle transport devices. In general, the detection and monitoring system monitors a portion of a beverage bottle transport device, and then utilizes the information to determine the condition of the beverage bottle transport device. For example, the detection and monitoring system could monitor a conveyor belt as it moves and record information regarding the condition of the conveyor belt. That information can then be compared with stored information to determine if the conveyor belt requires maintenance and/or repair. For example, dirt could build up on the conveyor belt, which dirt could cause mishandling of beverage bottles. If the dirt builds up to an amount sufficient to cause mishandling of beverage bottles, the detection and monitoring system alerts maintenance staff at the beverage bottling plant that maintenance and/or repair is required.

According to one possible exemplification, the detection and monitoring system could utilize polarized light in the monitoring and detection process. In that regard, it should be noted that the degree of polarization of the light reflected from a surface, such as the surface of a conveyor belt, is dependent on the type and extent of the respective stress damage. When observing a polarization plane of the light reflected from the surface, therefore, stressed regions of the surface, i.e. worn or dirt-contaminated regions, for example, appear as contrasting with surface regions which are not stressed. In addition, a different polarization takes place between the different types of stress and the respective intensity of stress. The degree of polarization of the light reflected from the conveyor belt surface is therefore dependent on the state of the surface of the conveyor belt.

A problematic issue with the temporally-spaced use of different polarization planes to determine the state of a surface, however, is that, with a moving surface, a distortion effect occurs which makes a determination of the state of the surface of the moving belt much more difficult, or even prevents or restricts or minimizes it altogether. It is all the more surprising, therefore, that by the simultaneous or substantially simultaneous detection of at least two polarization planes the distortion effects which occur, or other possible sources of interference in the polarization planes, can be filtered out. That is to say, the state of the surface of the conveyor belt is detected in each polarization plane which is possible for the optical system, and then processed by the optical system, for example, converted into data records, and then stored. During the determination, the optical system filters out the distortion effects or other interference such as reflections, and, on the basis of the filtered data/images of the polarization planes, determines the location of the stress, the respective type of stress, and, if appropriate, the degree of stress on the conveyor belt, i.e. the state of the surface of the respective section of the belt.

With the method it is therefore possible for the state of the surface of the entire conveyor belt to be determined on the basis of the contrast arising in the polarization planes between the individually differently stressed sections of the conveyor belt.

Accordingly, maintenance, upkeep, or even repair measures can be carried out on the conveyor belt as soon as corresponding full-surface or sectional changes of the state of the surface or surface states which deviate from a reference value have been detected by means of the method and the device. In other words, maintenance and/or repair can be performed on an as-needed basis.

In a further exemplification, the optical system can detect the surface state of the conveyor belt without coming in contact with it.

The term “conveyor belts” is also understood to include, for example, transport chains, i.e. all further configurations of conveyor belts also relate to transport chains. The conveyor belts can be configured, in particular, for the transport of beverage containers, such as drinks bottles, or cans made of plastic, glass, or metal. The conveyor belts and their surfaces respectively can comprise, for example, metal, plastic, or a composite material. In one possible exemplification, conveyor belts with a surface made of plastic have the possibility in this situation that light reflected from their surface is polarized.

That is to say, light rays which are reflected from the conveyor belt surface which is not stressed are polarized, while the light rays impinging on a stressed conveyor belt section, contaminated by dirt, for example, and reflected from it, are either not polarized or exhibit another degree of polarization, depending on the nature of the stress.

Conversely, with conveyor belts with a surface made of metal the light reflected from the surface is not polarized; by contrast, however, conveyor belt sections on which dirt contamination or similar is present can cause a polarization of the light reflected from their section, such that these sections accordingly again appear contrasting in the polarization planes.

When determining the state of the surface, particularly damage, surface tension stresses, and/or dirt contamination are detected, in particular a degree or a type of dirt contamination. These stresses on the belt surface all cause a change in the degree of polarization of the reflected light. For example, the detection of dirt contamination is particularly readily possible since, for example, fluids, grease, or even lubricants exhibit a degree of polarization of the light which perceptibly differs from that of the surface of the belt, such that these can be detected precisely or substantially precisely in the individually detected polarization planes, as contrast to the belt surface.

In this situation it is also possible, for example, for dirt contamination to be detected according to its type. For example, fluids or fluid films lying on the belt surface produce a contrast in the polarization planes of the light which differs from that of, for example, greases, lubricants, or metallic contaminants on the belt surface. In one possible exemplification, the method and device can be used to detect fluids or liquids present on the surface. As well as this, it is possible, for example, for an application of lubricant on the surface of the conveyor belt to be determined both in location as well as quantitatively, and for a lubricant application device to be controlled accordingly.

In order to determine the state of the surface with a moving conveyor belt it is necessary and/or desired, as already indicated, for at least two polarization planes of the reflected light to be detected. These polarization planes must or should, in addition, be detected simultaneously or substantially simultaneously, in order to allow for the determination of the surface state of the moving belt.

The optical system can accordingly be formed, for example, of two or more camera systems, in each case with an image sensor and the associated polarization filters. During the detection both camera systems are aligned onto the same section of the belt. In this situation, the optical system can, for example, detect the conveyor belt across its entire width. The optical system can also detect the conveyor belt, for example, only section by section in its width, and accordingly, for example after one complete run-through of the belt, it can change its position and detect another width section.

To simplify the detection process, according to a further exemplification of the present application the optical system comprises one single image sensor with polarization filter, which detects at least two or more polarization planes simultaneously or substantially simultaneously. Such optical systems are known. Such a system exhibits the possibility that it is perceptibly more economical than two systems connected in parallel, and, moreover, the processing of the data acquired by the optical system is perceptibly simplified. This makes it possible, in one possible exemplification, for the speed at which the conveyor belt runs past the optical system to be retained at its speed which is usual for the respective application.

In order to maintain continuous or substantially continuous monitoring of the state of the surface, the optical system permanently or substantially permanently detects the surface while the conveyor belt is in operation. As an alternative it is possible, for example, at specific time intervals, for the entire conveyor belt to be fully detected and compared with the data from a previous detection pass in order to determine any changes.

In order to improve the contrast in the polarization planes between the light reflected directly from the surface of the conveyor belt and from the section of the conveyor belt which is stressed, provision is made according to a further exemplification of the present application for the surface of the belt to be irradiated with a polarized light.

Polarized light may fall in a polarization plane onto the surface and is reflected from this. The use of polarized light is possible with conveyor belts with a metal surface, since metal surfaces do not cause any polarization of the light reflected onto them or from them. To this extent, with conveyor belts with a metal surface it is the reflected light rays which are polarized which are reflected from the stressed conveyor belt sections. That is to say, it is the dirt contaminated or damaged sections which are emphasised as contrasting in the polarization planes.

One possible feature of the present application is that the determination of the state of the conveyor belt surface takes place with a moving belt, i.e. the detection of the polarization planes takes place, for example, in the normal operation of the conveyor belt. According to a further exemplification of the present application, the detection of the polarization planes takes place at a belt run speed of at least two meters per second, in one possible exemplification at least two-and-a-half meters per second, for another possible exemplification at least three meters per second, and in yet another possible exemplification between two meters per second to five meters per second.

In order to improve the detection of the conveyor belt surface, provision is made according to a further exemplification of the present application that the optical system is configured for the detection of high-resolution images. As a result of this, it is possible for even very small evidence of stress to be detected, such as micro-fissures or changes in the microstructure of the conveyor belt, and also slight dirt contamination of the belt surface. In addition to this, the possibility of determining what type of stress and what type of dirt contamination is involved is perceptibly improved, and in which region of the conveyor belt surface they are located.

In order to be able to call up at a later date the state of the belt surface detected by the optical system, the state of the surface which is detected is, for one possible exemplification, processed by the optical system, in one possible exemplification represented as a digital value and stored. The digital values are unambiguous for the surface of the belt concerned, and represent, for example, a starting point value for the state of the surface, on the basis of which, and by comparison with at least one further detection pass, a change in the state of the conveyor belt surface can be detected. It is possible that, for the identification of a change in the surface state, this is determined once again, and compared with the surface state which was first detected and stored. It would therefore even be possible, for example, for a uniform change of the surface state over the entire surface to be determined. In another possible exemplification, calculated or desired values or states or data or images could possibly be used in the comparison with the actual information regarding the state of the conveyor belt.

The present application further solves the object by means of a device for determining the state of a conveyor belt surface on a moving conveyor belt with an optical system, which simultaneously or substantially simultaneously detects at least two polarization planes of the light reflected from the conveyor belt surface, and, by taking into consideration the polarization planes detected, the state of the surface is determined.

The device according to the present application is configured such as to detect at least two different polarization planes of the reflected light, and to filter out interferences in the polarization planes, such as distortion effects incurred by the movement of the conveyor belt. This can take place in such a way that the different polarization planes and the contrast differences which occur there, due to the different states of individual surface sections, are compared and in this way a determination of the state of the surface takes place, for example a determination of the position of the stressed region of the belt surface, of the respective type of stress, and/or of the intensity of the stress.

The device is accordingly configured in one possible exemplification so as to determine the different types of dirt contamination, such as fluids or liquids present in certain sections, such as water or even whole liquid films, on the basis of the contrast differences in the polarization planes. The device is also configured such as to detect, for example, a distribution of lubricant over the belt surface, and to determine whether there are regions present with too little lubricant or too high an application of lubricant. Accordingly, the device can be coupled, for example, to further control units, which, for example, control the application of the lubricant on the belt, or also carry out different maintenance, upkeep, or repair measures on the belt.

The conveyor belts to be examined can in principle be of any type, but comprise in one possible exemplification conveyor belts for the transport of beverage containers, which comprise at least one surface made of a plastic, a metal, or another composite material. Expressly included in these conveyor belts are also transport chains, which can be used, for example, for comparable purposes.

A particular possibility of the device is that it can be used universally for different types of conveyor belts, and does not have to be matched individually to a single conveyor belt. It is therefore possible, for example, for the device according to the present application to be located either fixed to a conveyor belt for long-term monitoring of the belt, but it can also be a mobile unit, which is used for the phase-by-phase monitoring of the surface state of a conveyor belt. A further possible exemplification of the device is that it does not form any direct contact between the optical system and the conveyor belt, but instead allows for contactless monitoring of the conveyor belt.

Although several aspects have been described in connection with a method, it is understood that these aspects also represent a description of the corresponding device. By analogy, aspects which have been described in connection with a device are also to be understood as a description of a corresponding method step or as a feature of a method step.

The above-discussed exemplifications of the present invention will be described further herein below. When the word “invention” or “exemplification of the invention” is used in this specification, the word “invention” or “exemplification of the invention” includes “inventions” or “exemplifications of the invention”, that is the plural of “invention” or “exemplification of the invention”. By stating “invention” or “exemplification of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

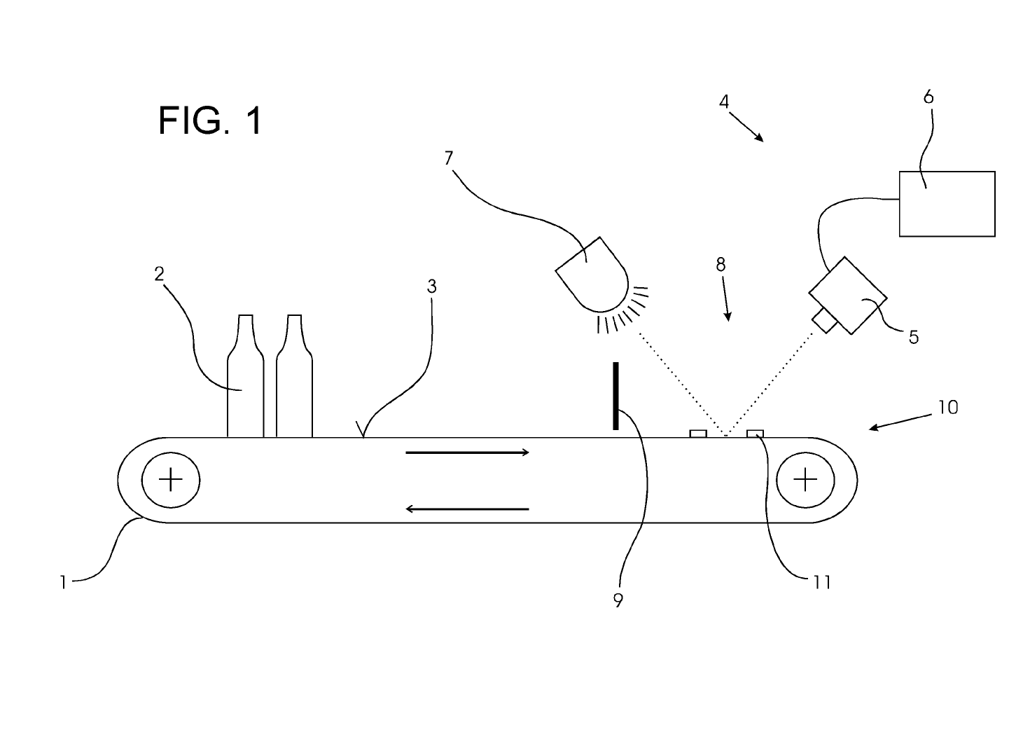

The present application is described in greater detail hereinafter on the basis of an exemplary exemplification. FIG. 1 shows in a schematic representation, a beverage bottle transport device, specifically a conveyor belt.

### DESCRIPTION OF EXEMPLIFICATION OR EXEMPLIFICATIONS

FIG. 1 shows schematically a conveyor belt 1 for the transport of beverage containers, in this case for the transport of drinks or beverage bottles 2. The conveyor belt 1 is configured as a transport chain, wherein each chain link (not represented here) comprises a conveyor belt surface 3 made of plastic.

FIG. 1 further shows an optical system 4 with a polarization camera 5, which comprises an image sensor (not represented here) with a polarization filter (not represented here), which detects four polarization planes simultaneously or substantially simultaneously. The polarization camera 5 is connected to a data storage and evaluation unit 6, which is configured such as to receive the polarization planes detected by the polarization camera 5, process them, and then store them as data records. In addition, a lighting unit 7 is arranged such that the region of the belt surface 3 detected by the polarization camera 5 is uniformly irradiated by polarizing light, such that the polarization camera 5 detects the light 8 which is polarized by the lighting unit 7 and reflected from the conveyor belt surface 2. In this situation, generally dependent on the inspection task, a light (8) can be used for the irradiation which must be determined in each case in respect of the type and intensity of light, and, in one possible exemplification, is changeable. The essential and/or desired parameters are in this situation the wavelengths and/or polarization planes, which, if appropriate, are used in a time-changeable manner.

A deflection unit 9 is also arranged, which steers the drinks bottles 2, upstream of the conveyor belt pressure guide and upstream of the detection region 10 of the conveyor belt surface 3, through the optical system 4 onto a further second conveyor belt (not represented here).

During the performance of the method, drinks bottles 2 are conveyed on the conveyor belt 1 in the transport direction (indicated by arrows) of the conveyor belt 1. The speed of the conveyor belt 1 in this situation is two and one-half meters per second. On reaching the deflection unit 9, the drinks bottles 2 are steered from the conveyor belt 1 onto a further conveyor belt.

After the beverage containers have been guided away, the conveyor belt 1 runs into the detection region 10 of the optical system 4. The detection region 10 comprises the entire width of the conveyor belt 1, and is uniformly illuminated by a lighting unit 7, in the present exemplification version, for example, by a polarized light 8. In this situation, the choice of the light or the wavelengths is dependent on the respective inspection task. The polarized light 8 impinges on the conveyor belt surface 3 made of plastic. The plastic in the conveyor belt surface 3 has the effect that, with the reflection of the light 8 on its surface, it changes the polarization plane of the light. The light rays reflected from the conveyor belt surface 3 are then detected by the polarization camera 5 in four different polarization planes. In this situation, the polarization plane of the light rays reflected at the areas of dirt contamination, reflected opposite the light rays which are reflected directly from the conveyor belt surface 3, undergoes another change of the polarization plane, such that the regions of the conveyor belt 1 in which dirt contamination is present are visible contrasted in the polarization planes detected by the polarization camera 5.

The four polarization planes detected by the polarization camera 5 are forwarded to the data storage and evaluation unit 6, and are stored as data. In this situation the data storage and evaluation unit 6 detects, for example, in which regions of the conveyor belt surface 3 what types of stresses are present, and, if appropriate, in what intensity (dirt contaminations, etc.), i.e. it detects what the state of the surface is. Due to the fact that the conveyor belt is continuously or substantially continuously monitored by the optical system 4, at every pass of the conveyor belt 1 through the detection region 10 a detection takes place of the dirty/stressed regions of the conveyor belt surface 3. By means of a data comparison, which is carried out, for example, by the data storage and evaluation unit 6, the change in the conveyor belt surface 3 can be determined, i.e. a change in the state of the surface. As soon as the conveyor belt surface 3 exceeds a reference value deposited in the data storage and evaluation unit 6, for example, or a maximum change which has been prearranged is reached, a maintenance and upkeep or repair interval for the conveyor belt 1 can be started.

After the rectification of the stress on the conveyor belt surface 3, or, if appropriate, also after each machine start, the conveyor belt 1 is again guided through the detection region 10 of the optical system 4, and the state of the belt surface 3 is detected in the cleaned, repaired state/start state, and stored as a data record. In the further course of the method, the assessment of the surface state of the conveyor belt surface 3 can be carried out on the basis of the recording of the surface state made after the maintenance and repair interval or, respectively, in the start state.

In this way it is possible, easily, for repair, upkeep, and maintenance intervals to be adjusted as required and/or desired so as to accord with the real state of the conveyor belt 1.

The present application relates to a method for determining the state of a conveyor belt surface. An optical system is provided in order to determine the state of the surface on a moving conveyor belt such that at least two polarization planes are simultaneously or substantially simultaneously detected by light, which is reflected by the surface of the conveyor belt, and the state of the surface is determined by taking into account the detected polarization planes.

One feature or aspect of an exemplification is believed at the time of the filing of this patent application to possibly reside broadly in a method for determining the state of a conveyor belt surface on a moving conveyor belt 1, wherein an optical system 4 at least simultaneously or substantially simultaneously detects two polarization planes of light 8 which is reflected from the surface 3 of the conveyor belt 1, and by taking account of the detected polarization planes, determines the state of the surface.

Another feature or aspect of an exemplification is believed at the time of the filing of this patent application to possibly reside broadly in the method, wherein damage, surface tension stresses, and/or dirt contamination present on the conveyor belt surface 3 is detected, in particular a degree of dirt contamination and/or a type of dirt contamination.

Yet another feature or aspect of an exemplification is believed at the time of the filing of this patent application to possibly reside broadly in the method, wherein the optical system 4 comprises an image sensor with polarization filter, which simultaneously or substantially simultaneously detects at least two or more polarization planes.

Still another feature or aspect of an exemplification is believed at the time of the filing of this patent application to possibly reside broadly in the method, wherein the surface 3 of the conveyor belt 1 is irradiated with a light 8, which can be changed in respect of the wavelength and/or polarization plane.

A further feature or aspect of an exemplification is believed at the time of the filing of this patent application to possibly reside broadly in the method, wherein the speed of the conveyor belt 1 at the detection of the polarization plane is at least two meters per second, in one possible exemplification at least two and one half meters per second, in another possible exemplification at least three meters per second, and in yet another possible exemplification between two meters per second to five meters per second.

Another feature or aspect of an exemplification is believed at the time of the filing of this patent application to possibly reside broadly in the method, wherein the optical system 4 is configured for the detecting of high-resolution images.

Yet another feature or aspect of an exemplification is believed at the time of the filing of this patent application to possibly reside broadly in the method, wherein the surface state which is detected is then processed, in one possible exemplification digitalized and stored.

Still another feature or aspect of an exemplification is believed at the time of the filing of this patent application to possibly reside broadly in the method, wherein, for the identification of a change in the surface state, this is again detected and then compared with the surface state data which was first detected and stored.

A further feature or aspect of an exemplification is believed at the time of the filing of this patent application to possibly reside broadly in a device for detecting a surface state on a moving conveyor belt 1 with an optical system 4, which simultaneously or substantially simultaneously detects at least two polarization planes of the light 8 reflected from the surface 3, and by taking account of the detected polarization planes, determines the state of the surface.

One feature or aspect of an exemplification is believed at the time of the filing of this patent application to possibly reside broadly in a method for determining the state of a conveyor belt surface transporting beverage containers, such as bottles, in a beverage container filling plant on a moving conveyor belt and determining a need for at least one of: maintenance and repair, said method comprising the steps of: loading containers on a conveyor belt; moving containers on said conveyor belt; unloading containers from said conveyor belt; simultaneously detecting, with an optical system, light from at least two polarization planes of light which are reflected from the surface of the moving conveyor belt, and comparing the polarized light detected in the polarization planes; evaluating the need for intervention into the state of said conveyor belt by comparing at least one of: stored evaluated data of actual faulty surfaces of a moving conveyor belt surface or calculated faulty surface characteristics of at least one moving conveyor belt surface with present characteristics of the moving present belt surface; detecting presence of at least one of: spills, dirt, debris, wear, and impending failure of the moving conveyor belt; and taking action to correct the at least one of: spills, dirt, debris, wear, and impending failure of the moving conveyor belt.

Another feature or aspect of an exemplification is believed at the time of the filing of this patent application to possibly reside broadly in the method, wherein damage, surface tension stresses, and/or dirt contamination present on the moving conveyor belt surface is detected, and/or a particular degree of dirt contamination and/or a type of dirt contamination.

Yet another feature or aspect of an exemplification is believed at the time of the filing of this patent application to possibly reside broadly in the method, wherein the optical system comprises an image sensor with polarization filter, which simultaneously detects at least two or more polarization planes.

Still another feature or aspect of an exemplification is believed at the time of the filing of this patent application to possibly reside broadly in the method, wherein the surface of the conveyor belt is irradiated with light, which can be changed in respect of the wavelength and/or polarization plane.

A further feature or aspect of an exemplification is believed at the time of the filing of this patent application to possibly reside broadly in the method, wherein the speed of the conveyor belt at a point of detection of the polarization polarized light is at least one of: 2 m/s, at least 2.5 m/s, at least 3 m/s, and between 2 m/s to 5 m/s.

Another feature or aspect of an exemplification is believed at the time of the filing of this patent application to possibly reside broadly in the method, wherein the optical system is configured for the detecting of high-resolution images.

Yet another feature or aspect of an exemplification is believed at the time of the filing of this patent application to possibly reside broadly in the method, wherein the surface state which is detected is then processed, and digitalized and stored.

Still another feature or aspect of an exemplification is believed at the time of the filing of this patent application to possibly reside broadly in the method wherein, for the identification of a change in the surface state, this is again detected and then compared with the surface state data which was first detected and stored.

A further feature or aspect of an exemplification is believed at the time of the filing of this patent application to possibly reside broadly in a device for operating by the method for detecting a surface state on a moving conveyor belt with an optical system, which simultaneously detects at least two polarization planes of the light reflected from the surface, and by taking account of the detected polarization planes, determines the state of the surface.

Another feature or aspect of an exemplification is believed at the time of the filing of this patent application to possibly reside broadly in the method wherein said method further comprises the step of comparing the polarized light immediately received images with stored images from originally stored or previous images of the moving conveyor belt.

The components disclosed in the patents, patent applications, patent publications, and other documents disclosed or incorporated by reference herein, may possibly be used in possible exemplifications of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one exemplification of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various exemplifications may be used with at least one exemplification or all of the exemplifications, if more than one exemplification is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications, patent publications, and other documents cited herein, and in the Declaration attached hereto, are hereby incorporated by reference as if set forth in their entirety herein except for the exceptions indicated herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, patent applications, patent publications, and other documents which are included in this application and which are referred to in paragraphs which state “Some examples of . . . which may possibly be used in at least one possible exemplification of the present application . . . ” may possibly not be used or useable in any one or more exemplifications of the application.

The sentence immediately above relates to patents, patent applications, patent publications, and other documents either incorporated by reference or not incorporated by reference.

The following patents, patent applications, patent publications, and other documents are hereby incorporated by reference as if set forth in their entirety herein, except for the exceptions indicated herein: DE 10 2008 014 334 A1, having the title “INTEGRATED POLARIZATION SENSOR”, published on Sep. 4, 2009; and DE 20 2012 010 977 U1, having the title “Messung einer Faserrichtung eines Kohlefaserwerkstoffes und Herstellung eines Objekts in Kohlefaserverbundbauweise”, published on Nov. 27, 2012.

All of the patents, patent applications, patent publications, and other documents, except for the exceptions indicated herein, which were cited in the German Office Action dated May 20, 2015, and/or cited elsewhere, as well as the German Office Action document itself, are hereby incorporated by reference as if set forth in their entirety herein except for the exceptions indicated herein, as follows: DE 10 2010 046 438 A1, having the title “Vorrichtung und Verfahren zur optischen Charakterisierung von Materialien”, published on Mar. 29, 2012; GB 2 183 332 A, having the title “Cinefilm fault detector”, published on Jun. 3, 1987; US 2007/096044, having the title “System and method of imaging the characteristics of an object”, published May 3, 2007; DE 10 2007 062 052 A1, having the title “Schichtdickenmessung an transparenten Schichten”, published on Jun. 25, 2009; and US 2012/194668, having the title “APPARATUS FOR DETECTING PARTICLES IN FLAT GLASS AND DETECTING METHOD USING SAME”, published on Aug. 2, 2012.

All of the patents, patent applications, patent publications, and other documents, except for the exceptions indicated herein, which were cited in the International Search Report dated Oct. 5, 2015, and/or cited elsewhere, as well as the International Search Report document itself, are hereby incorporated by reference as if set forth in their entirety herein except for the exceptions indicated herein, as follows: WO 2008/031648 A1, having the title “DEVICE FOR MONITORING A CONVEYING SYSTEM”, published on Mar. 20, 2008; JP H09 166552 A, having the title “SURFACE INSPECTION DEVICE”, published on Jun. 24, 1997; EP 1 507 137 A1, having the title “Method and apparatus for polarization dependent and spatially resolved inspection of a surface or layer”, published on Feb. 16, 2005; JP 2008 026060 A, having the title “FLAW INSPECTION DEVICE OF INSULATING FILM COVERED BELT-LIKE BODY”, published on Feb. 7, 2008; U.S. Pat. No. 6,988,610 B2, having the title “Conveyor belt inspection system and method”, published on Jan. 24, 2006; DE 31 06 568 A1, having the title “Arrangement for early fire detection on a belt conveyor”, published on Sep. 9, 1982; US 2006/114452 A1, having the title “Control device for a conveyor”, published on Jun. 1, 2006; DE 10 2005 055 655 A1, having the title “Conveyor belt condition determining device for e.g. mining industry, has evaluating device designed such that it compares two-dimensional images of belt sections detected by detection device with reference images assigned to sections”, published on May 31, 2007; US 2003/000808 A1, having the title “Device for monitoring a conveyor facility”, published on Jan. 2, 2003; US 2005/243310 A1, having the title “Method for inspecting insulating film for film carrier tape for mounting electronic components thereon, inspection apparatus for inspecting the insulating film, punching apparatus for punching the insulating film, and method for controlling the punching apparatus”, published on Nov. 3, 2005; EP 0 304 805 A2, having the title “Optical scanning apparatus for a transparent web of material”, published on Mar. 1, 1989; EP 0 052 813 A2, having the title “Method for the examination of a moving reflecting or transparent sheet, and device for carrying out said method”, published on Jun. 2, 1982; and DE 10 2008 014 334 A1, having the title “INTEGRATED POLARIZATION SENSOR”, published on Sep. 24, 2009.

The corresponding foreign and international patent publication applications, namely, Federal Republic of Germany Patent Application No. 10 2014 112 886, filed on Sep. 8, 2014, having inventors Carsten BUCHWALD, Jürgen-Peter HERRMANN, Marius Michael HERRMANN, Wolfgang SCHORN, and Xiang ZHANG, and DE-OS 10 2014 112 886 and DE-PS 10 2014 112 886, and International Application No. PCT/EP2015/066030, filed on Jul. 14, 2015, having WIPO Publication No. WO 2016/037735, and inventors Carsten BUCHWALD, Jürgen-Peter HERRMANN, Marius Michael HERRMANN, Wolfgang SCHORN, and Xiang ZHANG, are hereby incorporated by reference as if set forth in their entirety herein, except for the exceptions indicated herein, for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications, patent publications, and other documents, except for the exceptions indicated herein, are hereby incorporated by reference as if set forth in their entirety herein except for the exceptions indicated herein.

The purpose of incorporating the corresponding foreign equivalent patent application(s), that is, PCT/EP2015/066030 and German Patent Application 10 2014 112 886, is solely for the purposes of providing a basis of correction of any wording in the pages of the present application, which may have been mistranslated or misinterpreted by the translator, and to provide additional information relating to technical features of one or more exemplifications, which information may not be completely disclosed in the wording in the pages of this application.

Statements made in the original foreign patent applications PCT/EP2015/066030 and DE 10 2014 112 886 from which this patent application claims priority which do not have to do with the correction of the translation in this patent application are not to be included in patent application in the incorporation by reference.

Any statements about admissions of prior art in the original foreign patent applications PCT/EP2015/066030 and DE 10 2014 112 886 are not to be included in this patent application in the incorporation by reference, since the laws relating to prior art in non-U.S. Patent Offices and courts may be substantially different from the Patent Laws of the United States.

All of the references and documents cited in any of the patents, patent applications, patent publications, and other documents cited herein, except for the exceptions indicated herein, are hereby incorporated by reference as if set forth in their entirety herein except for the exceptions indicated herein. All of the patents, patent applications, patent publications, and other documents cited herein, referred to in the immediately preceding sentence, include all of the patents, patent applications, patent publications, and other documents cited anywhere in the present application.

Words relating to the opinions and judgments of the author of all patents, patent applications, patent publications, and other documents cited herein and not directly relating to the technical details of the description of the exemplifications therein are not incorporated by reference.

The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned words in this sentence, when not used to describe technical features of one or more exemplifications of the patents, patent applications, patent publications, and other documents, are not considered to be incorporated by reference herein for any of the patents, patent applications, patent publications, and other documents cited herein.

The description of the exemplification or exemplifications is believed, at the time of the filing of this patent application, to adequately describe the exemplification or exemplifications of this patent application. However, portions of the description of the exemplification or exemplifications may not be completely applicable to the claims as originally filed in this patent application, as amended during prosecution of this patent application, and as ultimately allowed in any patent issuing from this patent application. Therefore, any statements made relating to the exemplification or exemplifications are not intended to limit the claims in any manner and should not be interpreted as limiting the claims in any manner.

The details in the patents, patent applications, patent publications, and other documents cited herein may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the exemplification or exemplifications, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The exemplifications of the invention described herein above in the context of the preferred exemplifications are not to be taken as limiting the exemplifications of the invention to all of the provided details thereof, since modifications and variations thereof may be made without departing from the spirit and scope of the exemplifications of the invention.

### AT LEAST PARTIAL NOMENCLATURE

1 Conveyor belt
2 Drinks bottles
3 Conveyor belt surface
4 Optical system
5 Polarization camera
6 Data storage and evaluation unit
7 Lighting unit
8 Light ray
9 Deflection unit
10 Detection region
11 Dirt contamination areas

1. Method for determining the state of a conveyor belt surface transporting beverage containers, such as bottles, in a beverage container filling plant on a moving conveyor belt and determining a need for at least one of: maintenance and repair, said method comprising the steps of:
loading containers on a conveyor belt;
moving containers on said conveyor belt;
unloading containers from said conveyor belt;
simultaneously detecting, with an optical system, light from at least two polarization planes of light which are reflected from the surface of the moving conveyor belt, and
comparing the polarized light detected in the polarization planes;
evaluating the need for intervention into the state of said conveyor belt by comparing at least one of: stored evaluated data of actual faulty surfaces of a moving conveyor belt surface or calculated faulty surface characteristics of at least one moving conveyor belt surface with present characteristics of the moving present belt surface;
detecting presence of at least one of: spills, dirt, debris, wear, and impending failure of the moving conveyor belt; and
taking action to correct the at least one of: spills, dirt, debris, wear, and impending failure of the moving conveyor belt.

2. The method according to claim 1, wherein damage, surface tension stresses, and/or dirt contamination present on the moving conveyor belt surface is detected, and/or a particular degree of dirt contamination and/or a type of dirt contamination.

3. Method according to claim 2, wherein the optical system comprises an image sensor with polarization filter, which simultaneously detects at least two or more polarization planes.

4. Method according to claim 3, wherein the surface of the conveyor belt is irradiated with light, which can be changed in respect of the wavelength and/or polarization plane.

5. Method according to claim 4, wherein the speed of the conveyor belt at a point of detection of the polarization polarized light is at least one of: 2 m/s, at least 2.5 m/s, at least 3 m/s, and between 2 m/s to 5 m/s.

6. Method according to claim 5, wherein the optical system is configured for the detecting of high-resolution images.

7. Method according to claim 6, wherein the surface state which is detected is then processed, and digitalized and stored.

8. Method according to claim 7, wherein, for the identification of a change in the surface state, this is again detected and then compared with the surface state data which was first detected and stored.

9. Device for operating by the method of claim 1 for detecting a surface state on a moving conveyor belt with
an optical system, which simultaneously detects at least two polarization planes of the light reflected from the surface, and
by taking account of the detected polarization planes, determines the state of the surface.

10. Device for operating by the method of claim 2 for detecting a surface state on a moving conveyor belt with
an optical system, which simultaneously detects at least two polarization planes of the light reflected from the surface, and
by taking account of the detected polarization planes, determines the state of the surface.

11. Device for operating by the method of claim 3 for detecting a surface state on a moving conveyor belt with
an optical system, which simultaneously detects at least two polarization planes of the light reflected from the surface, and
by taking account of the detected polarization planes, determines the state of the surface.

12. Device for operating by the method of claim 4 for detecting a surface state on a moving conveyor belt with
an optical system, which simultaneously detects at least two polarization planes of the light reflected from the surface, and
by taking account of the detected polarization planes, determines the state of the surface.

13. Device for operating by the method of claim 5 for detecting a surface state on a moving conveyor belt with
an optical system, which simultaneously detects at least two polarization planes of the light reflected from the surface, and
by taking account of the detected polarization planes, determines the state of the surface.

14. Device for operating by the method of claim 6 for detecting a surface state on a moving conveyor belt with
an optical system, which simultaneously detects at least two polarization planes of the light reflected from the surface, and
by taking account of the detected polarization planes, determines the state of the surface.

15. Device for operating by the method of claim 7 for detecting a surface state on a moving conveyor belt with
an optical system, which simultaneously detects at least two polarization planes of the light reflected from the surface, and
by taking account of the detected polarization planes, determines the state of the surface.

16. Device for operating by the method of claim 8 for detecting a surface state on a moving conveyor belt with
an optical system, which simultaneously detects at least two polarization planes of the light reflected from the surface, and
by taking account of the detected polarization planes, determines the state of the surface.

17. Method according to claim 1 wherein said method further comprises the step of comparing the polarized light immediately received images with stored images from originally stored or previous images of the moving conveyor belt.

18. Method according to claim 1, wherein the optical system comprises an image sensor with polarization filter, which simultaneously detects at least two or more polarization planes.

19. Method according to claim 18, wherein the surface of the conveyor belt is irradiated with light, which can be changed in respect of the wavelength and/or polarization plane.

20. Method according to claim 19, wherein the speed of the conveyor belt at a point of detection of the polarization polarized light is at least one of: 2 m/s, at least 2.5 m/s, at least 3 m/s, and between 2 m/s to 5 m/s.
